(19) United States
(12) Patent Application Publication
(10) Pub. No.: US 2017/0073071 A1
(43) Pub. Date: Mar. 16, 2017

(54) UNMANNED AIRCRAFT AND UNMANNED GROUND VEHICLE TEAMING FOR REMOTE INFRASTRUCTURE INSPECTION

(71) Applicant: Guided Systems Technologies, Inc., Stockbridge, GA (US)

(72) Inventors: Jared David Salzmann, McDonough, GA (US); J Eric Corban, McDonough, GA (US)

(73) Assignee: Guided Systems Technologies, Inc., Stockbridge, GA (US)

(21) Appl. No.: 15/358,081

(22) Filed: Nov. 21, 2016

Related U.S. Application Data
(60) Provisional application No. 62/258,290, filed on Nov. 20, 2015.

(51) Int. Cl. B64D 1/22; B60Q 1/02; B64D 1/02; G05D 1/00; B64C 39/02; B64D 47/08

(52) U.S. Cl. CPC B64D 1/22; B64C 39/024; B64D 47/08; B64D 1/02; G05D 1/0033; G05D 1/0038; G05D 1/0094; B60Q 1/02

(57) ABSTRACT

Infrastructure is remotely inspected using a sensor pod such as an unmanned ground vehicle and sensors adapted to inspect a surface of the infrastructure and an unmanned aircraft adapted to interoperate with the sensor pod. The sensor pod drives along the surface of the infrastructure being inspected. A tether to the unmanned aircraft deploys and retrieves the sensor pod on the surface of the infrastructure. Electronic sensors of the sensor pod are deployable in a crevice of the surface of the infrastructure obstructed from view by the unmanned aircraft. The unmanned aircraft can comprise a radio repeater adapted to relay ground commands to the sensor pod.

### BACKGROUND OF THE INVENTIONS

1. Technical Field

The present inventions relate to aircraft and inspecting hard to reach or shrouded features of infrastructure and, more particularly, the remote inspection of infrastructure using unmanned ground vehicles put into position by unmanned aircraft.

2. Description of the Related Art

The inspection of vents, flues, pumps, skylights, HVAC (heating, ventilation and air conditioning) equipment, lighting, flashing and other infrastructure is well documented. These features of infrastructure are often located in places that are difficult or dangerous for a worker to access, for example, equipment or features on the roof of a building, or exterior surfaces of a municipal water tower. Traditional methods for safely accessing these features of infrastructure for the purposes of inspection typically require work crews to erect scaffolding or use rope and or cranes to traverse the exterior of a structure. These methods are expensive, time consuming, and hazardous. Small unmanned aircraft can be outfitted with various sensor packages to remotely perform many of these inspection tasks more safely and cost-effectively. This can allow for benefits such as minimized risk to personnel and increased frequency of inspections. An increased frequency of inspections can allow for benefits such as improved regulation compliance, more efficient operation and early identification of structural defects. However, the ability of unmanned aircraft to remotely inspect infrastructure is limited to what can be observed directly from the aircraft via line-of-sight. In many cases, areas requiring inspection cannot be directly observed from the aircraft via line-of-sight due to obstructions between the aircraft and the area requiring inspection.

The ability of small unmanned aircraft to visually inspect the exterior of municipal water towers has been demonstrated. However, because the working components of a municipal water tower vent are often shrouded to prevent rain water from entering the tank, they are not directly visible from any appreciable distance or angle and thus cannot be properly inspected using the unmanned aerial vehicle alone.

### BRIEF DESCRIPTION OF THE DRAWINGS

The present inventions are illustrated by way of example and are not limited by the accompanying figures, in which like references indicate similar elements. Elements in the figures are illustrated for simplicity and clarity and have not necessarily been drawn to scale.

The details of the preferred embodiments will be more readily understood from the following detailed description when read in conjunction with the accompanying drawings wherein:

FIG. 1 illustrates an aerial view of an unmanned aircraft hovering above a water tower ready to lower a sensor vehicle near the vent of the water tower using a length of tether according to embodiments of the present inventions;

FIG. 2 illustrates a side view of an unmanned aerial vehicle integrated with an electromechanical hoist used for raising and lowering its slung load, embodied as a sensor pod, near the vent of a water tower using a length of tether according to embodiments of the present inventions;

FIG. 3 illustrates a detailed side view of the electromechanical hoist according to embodiments of the present inventions;

FIG. 4 illustrates a side view of an electromechanical hoist being detached from the unmanned aircraft using an electromechanical actuated release mechanism according to embodiments of the present inventions;

FIG. 5 illustrates a front view of a sensor vehicle that can be slung below an unmanned aircraft by a tether and lowered near the vent of a municipal water tower for remotely inspecting the interior of its vent according to embodiments of the present inventions; and

FIG. 6 illustrates a front view by which a sensor vehicle maneuvers along the surface of infrastructure to remotely inspect features thereof according to embodiments of the present inventions.

### DETAILED DESCRIPTION OF THE PREFERRED EMBODIMENTS

Methods and tools for utilizing a small unmanned aircraft to position a small unmanned ground vehicle in hard to reach areas for the purpose of inspecting infrastructure not directly visible from the unmanned aircraft while in flight, specifically the shrouded working components of a municipal water tower vent, is a primary utility of the instant inventions.

Infrastructure and equipment that needs to be regularly inspected can often be hidden or shrouded from direct view. For example, air vents found on municipal water towers. These vents often consist of a wire mesh or grated screen that must be regularly inspected to insure it is clear of debris and able to vent air to and from the interior of the water tower. Not only are these vents located in a hard to reach environment, in this case the top of the water tower, they are often shrouded by a cover to prevent rain water intrusion. The cover obstructs the view of the top and sides of the vent which denies direct visual inspection of the vent from anywhere but underneath the cover. Traditionally, this inspection requires a worker to traverse the exterior of the water tower, high above the ground, using ropes and then visually inspect the vent by looking underneath the cover. The ability to remotely inspect a water tower vent such as described above or any other hard to reach or shrouded feature of infrastructure using robotics would eliminate the need for such high risk tasks, saving money and time. In order to remotely perform an inspection of these hard to reach and often shrouded features of infrastructure using robotics it is necessary to first position the remote sensing components into a high risk or hard to reach environment and then maneuver them, by their own locomotion, to the target area of interest, such as underneath a cover or through a shaft. Tedious inspections of this nature are required with many types of infrastructure such as flues, pumps, skylights, HVAC (heating, ventilation and air conditioning), equipment, lighting, and flashing. In many cases, these hard to reach or shrouded features of infrastructure are located on the exterior walls of tall structures and very difficult to reach from anywhere but outside the structure. This requires the sensing components be positioned using an unmanned aircraft. The unmanned aircraft can be utilized as a crane to position one or more sensor pods onto the exterior surfaces of a tall structure or feature of infrastructure. The sensor pod can then be maneuvered by its own locomotion along said surface in order to precisely position its remote sensing payloads into the tight spaces or difficult to reach areas that contain features requiring inspection. The sensor pod can be embodied as a remotely or autonomously controlled ground vehicle/robot. Locomotion of the sensor pod can be achieved by numerous means including but not limited to wheels, tracks, or actuated legs. Once in placed on the surface of infrastructure, the sensor pod can be detached from the unmanned aircraft, which can then be tasked elsewhere or returned for landing while the sensor pod inspects one or more features of the structure or infrastructure of interest. Likewise, the sensor pod may remain connected to the unmanned aircraft while performing its inspections. Once positioned on the surface of infrastructure by the unmanned aircraft, the sensor pod can then be used to remotely inspect the structure or infrastructure of interest, repositioning itself along said surface by any means of locomotion. For the example of municipal water tower vents, the entire circumference of the interior walls and grating of the vent can be inspected by remotely maneuvering the sensor pod's remote sensing payload underneath the cover and then driving it around along the surface around the vent.

The sensor pod can be fitted with one or more sensors for remotely inspecting infrastructure. These can include but are not limited to cameras of any type with electro-optical or infrared sensors, LIDAR sensors, sonar sensors, barometric ambient air pressure sensors, ultra-sonic sensors for non-destructive testing, laser distance sensor, radar, ambient thermal sensors, radiation sensors, air sample sensors and remote thermal sensors. Likewise, the sensor pod can be fitted with one or more robotic arms to manipulate objects or to extend the reach of a sensor. The sensor pod can also be fitted with a plurality of lights which can be embodied as light emitting diodes (LED) to continuously illuminate the infrastructure that is to be inspected or to navigate the sensor pod about. Likewise, the lights can be embodied as short duration flash light (e.g. flash photography) to periodically illuminate the infrastructure to be inspected.

The sensor pod can be mounted directly to the airframe of the unmanned aircraft or slung below using a tether. A hoist can be mounted to the unmanned aircraft with which to raise and lower the sensor pod relative to the unmanned aircraft. The hoist can comprise one or more electric motors and gearboxes as well as a drum or lift-wheel around which tether, rope or cable wraps. The hoist is comprised of integrated radio receivers for remote control of said electric motors by operators from the ground as well as can be controlled through an electronic interface with the unmanned aircraft. An electromechanical brake can be used to prevent unwinding of the drum in the case of failure of the electric motor. A miniature computer can also be programmed to control the electric motors at a specific rate and or to a specific altitude either by an operator or as a part of a pre-programmed action. An actuated release mechanism can be mounted to the unmanned aircraft, wherein the hoist comprises a mechanical interface compatible with the actuated release mechanism mounted on the unmanned aircraft. Likewise, the hoist can comprise an actuated release mechanism for detaching the hoist from the aircraft while in flight or at any other time and the unmanned aircraft can comprise a mechanical interface compatible with the actuated release mechanism mounted on the hoist. A tether, rope or cable, which can be embodied as braided high strength fibers, is spooled onto the drum or lift-wheel of the hoist and then used to suspend the sensor pod, embodied as a ground robot, below the unmanned aircraft for transport. Likewise, the hoist can be integral to the sensor vehicle or pod with the tether, rope or cable attached to the unmanned aircraft. The tether can also be embodied as a fiber-optic data link or conductive communications wire to transmit data and power between the unmanned aircraft and the sensor vehicle.

A positive capture mechanism comprising may be integrated with the tether to allow the sensor pod and the unmanned aircraft to decouple from one another. The positive capture mechanism would allow the unmanned aircraft to detach the sensor pod once placed securely in position on the surface of infrastructure for beginning its remote inspection task. In order to aid in re-coupling the sensor pod to the unmanned aircraft for extraction, any number of visual or proximity sensors may be used on either the unmanned aircraft, the tether, the clasp, the positive capture mechanism or the sensor vehicle. The positive capture mechanism may incorporate a variety of materials and positive methods with which to couple with the sensor pod, including but not limited to magnets, spring rings, lobster claws, bayonet clasps, barrel clasps, toggles, hooks, pearl clasps, hook and eye, hook-and-loop, any of which may either operate passively, actively (e.g. by use of a servomechanism), or via the use of springs. A cradle may also be integrated with the tether upon which the sensor pod can drive on and off of it.

A swivel device is located along the hoisting tether, rope or cable, to allow the sensor pod, the unmanned aircraft and tether to rotate freely relative to each other. If the hoisting tether is embodied as a cable with power or communications link, slip ring devices can be integrated with the swivel device and the hoist.

The sensors and related equipment mounted in the sensor pod can be mounted through a series of one or more axis of rotation. When these axes are actuated, embodied as a single or multi axis sensor gimbal, the sensor can be stabilized relative to the sensor pod or can be pointed by the operator. The sensor pod can be integrated with one or more robotic arms to manipulate objects or to extend the reach of a sensor. The robotic arm can comprise one or more robotic manipulators.

A distance sensor may be used to measure and record the altitude or vertical position of the sensor pod relative to the unmanned aircraft. Likewise, a distance sensor may be used to measure and record the altitude or vertical position of the sensor pod relative to the infrastructure of interest to assist in positioning the sensor pod at a specific point on the surface of the infrastructure and prevent winching out too much tether, as this may cause unnecessary slack in the line. The altitude data can be displayed in real time to an operator or can be incorporated into an automatic feedback control algorithm that regulates hoisting speed as well as where the hoisting will stop. Any number of other sensors can be used to measure and record the vertical position of the sensor pod relative to the unmanned aircraft and/or infrastructure, such as a laser distance sensor, LIDAR sensor, radar distance sensor, ultrasonic distance sensors, computer vision based odometer sensor, inertial navigation unit, and infrared temperature sensors. In addition, a hoisting odometer can be installed in the hoist mechanism that can be used to estimate the altitude of the sensor pod relative to the unmanned aircraft and/or infrastructure. The sensor pod can comprise a battery to power its integrated electronics and sensors.

A magnetic and/or GPS sensor is used to measure and record the magnetic heading and/or position of the sensor pod in order to correlate gathered inspection data with a physical location on or along the inspected infrastructure. In addition, this heading and position data can be used to locate a specific point on the infrastructure. The heading and position data can be displayed real time to an operator or can be incorporated into an automatic feedback control algorithm that, for example, slowly maneuvers the sensor vehicle around an object to be inspected in order to observe said object from multiple angles. Any number of other sensors can be used to measure and record the heading and position of the sensor vehicle relative to the infrastructure, such as an inertial navigation sensor or a computer-vision based navigation solution. The sensor pod can contain an integrated processor and computing elements to allow for autonomous operation and vision based navigation.

The sensor pod's heading or yaw axis is controlled using a steering mechanism integrated with the sensor pod. A number of wheels or mechanical legs may be used in order to propel and turn the sensor vehicle across the surface of the infrastructure. Each motor or mechanical leg can be powered by one or more electric motors or servomechanisms. The electric motors or servomechanisms can be driven clockwise or anti-clockwise at different speeds such that the wheels or mechanical legs can be used to produce forward or rearward motion as well as turning motion in any direction. The wheels can be actuated. Likewise, an additional servomotor may be placed on the sensor vehicle in order to change its direction of travel. Angular rate (e.g. MEMS) and/or heading (e.g. magnetometer) and/or proximity (e.g. infrared) sensors detect the heading and position of the sensor vehicle and a closed loop feedback control algorithm can be used to command said electric motors to power said motors or servomechanisms in order to automatically drive the sensor vehicle to, from and around infrastructure that is to be inspected or circumvented.

The sensor pod and/or sensitive components thereof can be fully sealed to allow easy cleaning if the sensor pod comes in contact with a contaminated surface or contaminated air. One or more plastic or rubber gaskets can be used to seal the sensor pod. The sensor vehicle and/or sensitive components can be heat resistant or sufficiently cooled, either actively or passively, to allow entry of the sensor pod in a hot environment.

One or more data receivers can be integrated with the sensor pod, also known as a sensor vehicle, and receive commands from operators on the ground. The commands can be distributed to the sensor, sensor accessories, lights, the hoist and the sensor vehicle heading and position control mechanisms. Sometimes the sensor vehicle will be out of range with the ground and operates autonomously or the ground commands can be relayed through the unmanned aircraft acting as a radio repeater.

One or more video and data transmitters can be integrated with the sensor pod and transmit real time video and or data to a receiver integrated with the unmanned aircraft which can then be rebroadcast to operators on the ground. Likewise, the sensor pod can directly transmit data from the sensor pod to operators on the ground.

To inspect infrastructure, for example the vent of a municipal water tower, by teaming an unmanned ground vehicle and an unmanned aircraft the following method is used. An unmanned aircraft, embodied as a rotorcraft, is outfitted with an electromechanical hoist. It should be noted that the unmanned aircraft can be embodied as an air vehicle of any type as well as the hoist could be replaced with a fixed length tether. The hoist is spooled with a tether which can be embodied as rope, cable, filament or high-strength braided fiber. At the end of said tether, rope or cable a sensor pod, embodied as an unmanned ground vehicle, is attached. The unmanned aircraft is launched, either manually, semi-autonomously, or autonomously, from a take-off site located in close proximity to the infrastructure to be inspected with the sensor pod slung below. The unmanned aircraft can have tall landing gear to facilitate locating the sensor pod directly underneath the unmanned aircraft for takeoff. Likewise, the sensor pod can be placed next to the unmanned aircraft and subsequently picked up when the unmanned aircraft takes off. Once in flight the unmanned aircraft and its slung sensor pod payload is navigated, either autonomously, semi-autonomously, or manually, to a position near or above the infrastructure to be inspected. Once in position the unmanned aircraft is commanded to hover at this GPS position. At this time, the slung sensor pod payload is lowered onto the surface of the structure or infrastructure to be inspected using said electromechanical hoist or by changing the altitude of the unmanned aircraft. The sensor pod, if desired, may then be remotely detached from the tether using an integrated positive capture mechanism or clasp and then remotely driven across the surface, either manually, semi-autonomously, or autonomously, to locate the inspection areas of interest, for example a water tower vent. Once detached from the sensor pod, the unmanned aircraft may return to the launch site, or complete another operation. In the case of a water tower vent, the sensor pod is remotely driven to the vent, and is then commanded to travel underneath the vent lip partially and position a camera into the vent as needed. The sensor pod may reposition itself, either manually, semi-autonomously, or autonomously, in and around the vent or in and around other items to be inspected. Operators on the ground can manually drive the sensor pod in first person view using cameras integrated on the sensor pod as well as in third person view from the vantage point of the unmanned aircraft using cameras integrated with the unmanned aircraft. The sensor pod can autonomously navigate and identify that it has made a complete inspection of required objects by measuring its heading and position using heading and positions sensors previously mentioned. Likewise, the operator can identify the sensor pod has made a complete inspection of required objects using a video or data feed being transmitted from the sensor vehicle, to the helicopter and then relayed to the operator on the ground. Likewise the video or data feed can be transmitted directly from the sensor vehicle to the operator on the ground. As the sensor pod is inspecting different infrastructure objects, data is collected by one or more electronic sensors that can include but are not limited to cameras of any type with electro-optical or infrared sensors, LIDAR sensors, sonar sensors, barometric ambient air pressure sensors, ultra-sonic sensors for non-destructive testing, laser distance sensor, radar, ambient thermal sensors, radiation sensors, air sample sensors and remote thermal sensors. The data collected by these sensors can be stored on a data storage device integrated with the sensor vehicle or sensors themselves. Likewise the data collected by these sensors can be transmitted to the unmanned aircraft for storage. Likewise the data collected by these sensors can be transmitted to the ground for storage or for viewing in real time by an operator. The maneuvering of the sensor pod can be stopped at any time at the command of the operator to more carefully inspect any given area of interest. Once the sensor vehicle has completed inspections, the unmanned aircraft is then commanded to retrieve the sensor pod, if they have been detached, by hovering above it, lowering it's positive capture mechanism using said electromechanical hoist and coupling with the sensor pod using said positive capture mechanism or actuated clasp. Once securely coupled, the sensor pod can be extracted from atop infrastructure and returned to the landing site either autonomously, semi-autonomously, or manually as payload of the unmanned aircraft. The unmanned aircraft can have tall landing gear to facilitate locating the sensor pod directly under the unmanned aircraft during landing. Likewise, the sensor vehicle can be lowered next to the landing site and the unmanned aircraft subsequently lands at the landing site.

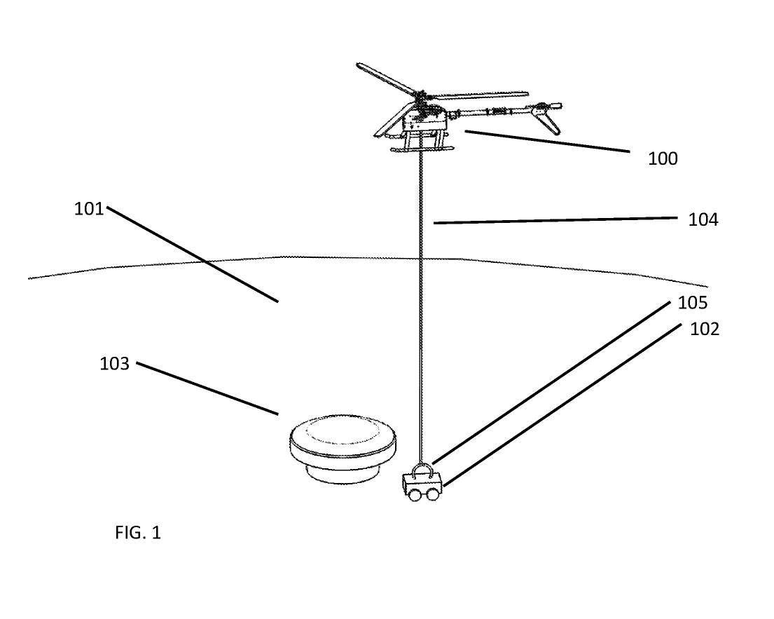

FIG. 1 illustrates an aerial view of an unmanned aircraft 100 hovering above a water tower 101 ready to lower a sensor vehicle 102 near the vent 103 of a water tower 101 using a length of tether 104 according to embodiments of the present inventions. In FIG. 1, the illustrated unmanned aircraft 100 is embodied as a rotor-craft and lowers a slung payload, embodied as a sensor pod 102, suspended by a tether 104 near the vent 103 of a water tower 101. The sensor pod 102, embodied as an unmanned ground vehicle, is lowered onto the surface of the water tower 101 for the purpose of inspecting the water tower's air vent. The unmanned aircraft is positioned above the water tower, which can be embodied as any structure or infrastructure, and an electromechanical hoist 200 integrated with the unmanned aircraft 100 is commanded to lower the sensor pod 102 onto the surface of the water tower 101. Once on the surface, the sensor pod may or may not be decoupled from the tether 104 using a positive capture mechanism 105. The sensor pod 102 can be embodied as an unmanned ground vehicle or robot that can be driven on the surface of the water tower 101 around the vent 101, while one or more sensors integrated with the sensor vehicle 102 remotely collect various data to be used for assessing the condition of the infrastructure, or features thereof, being inspected.

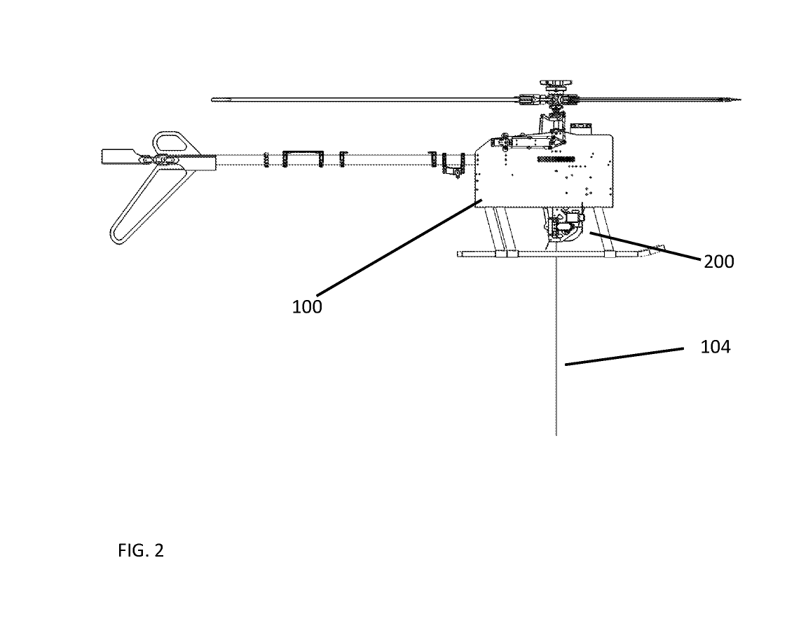

FIG. 2 illustrates a side view of an unmanned aircraft 100 integrated with an electromechanical hoist 200 used for raising and lowering its slung load such as slung sensor pod 102 payload onto and off of the surface of the water tower 101 according to embodiments of the present inventions. The sensor pod 102 is suspended from the electromechanical hoist by a length of a tether 104, near the vent 103 of a water tower 101.

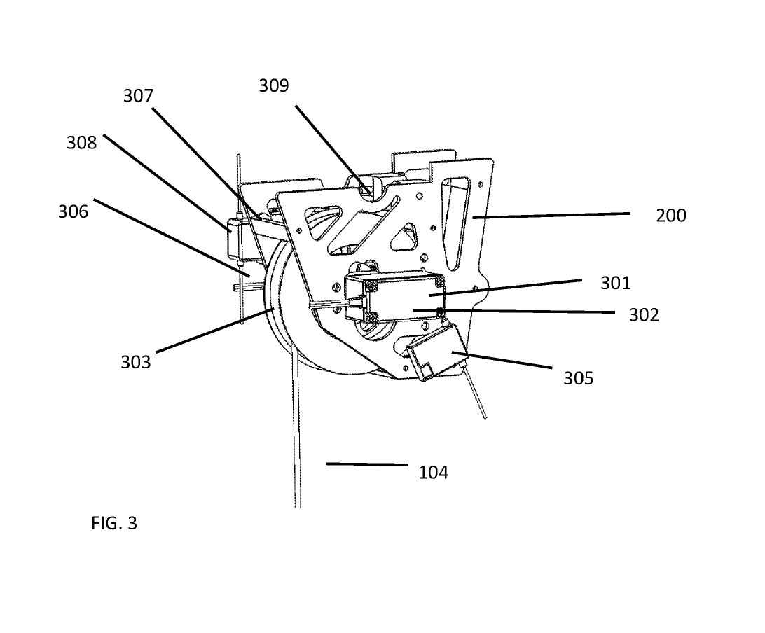

FIG. 3 illustrates a detailed side view of the electromechanical hoist 200 according to embodiments of the present inventions. The electromechanical hoist 200 can comprise one or more electric motors 301. The electric motors 301 can be embodied with integrated gearboxes 302. Said motors 301 and integrated gearboxes 302 drive a drum 303 around which a tether, rope or cable 104 wraps. Integrated radio receivers 305 enable remote control of the electric motors 301 by operators on the ground. Likewise, the electric motors 301 can be controlled through a wired interface 306 with the unmanned aircraft 100. An electromechanical brake 307 can be integrated to prevent unwinding of the drum 303 in the case of failure of the electric motor 301. A miniature computer 308 can also be programmed to control the electric motors 301 at a specific rate and or to a specific altitude either by an operator or as part of a pre-programmed action. The tether 104, which can be embodied as braided high strength fibers, is spooled onto the drum 303 of the electromechanical hoist 200 and then used to suspend the sensor pod 102 below the unmanned aircraft 100 for inspecting infrastructure 103. The tether 104 can also be embodied as a fiber-optic data link or conductive communications wire to transmit data and power between the unmanned aircraft 100 and the sensor pod 102. If the tether 104 is embodied as a cable with power or communications link, slip ring devices can be integrated with the drum 303. In addition, a hoisting odometer 309 can be installed in the electromechanical hoist 200 that can be used to estimate the altitude of the sensor pod 102 relative to the unmanned aircraft 100 and/or surface of the infrastructure to be inspected.

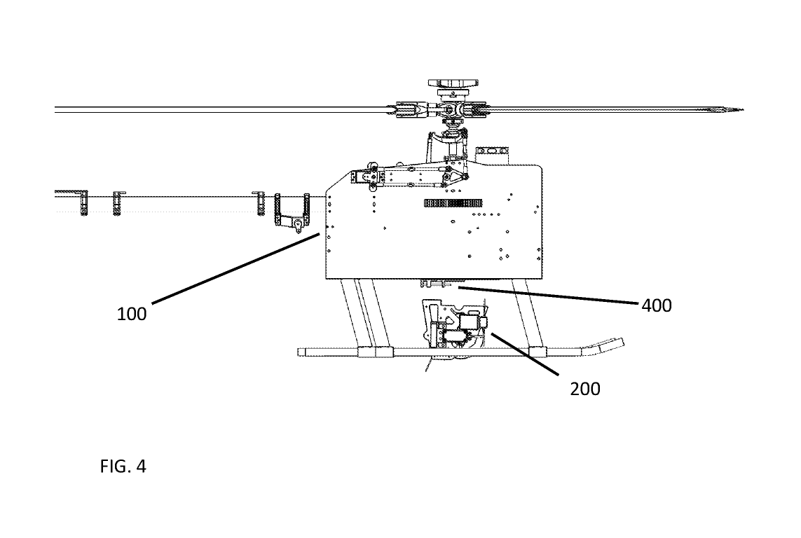

FIG. 4 illustrates a side view of an electromechanical hoist 200 being detached from the unmanned aircraft 100 using an actuated release mechanism 400 according to embodiments of the present inventions. The actuated release mechanism 400 is integrated with the unmanned helicopter 100. Likewise, the actuated release mechanism 400 can be integrated with the electromechanical hoist 200.

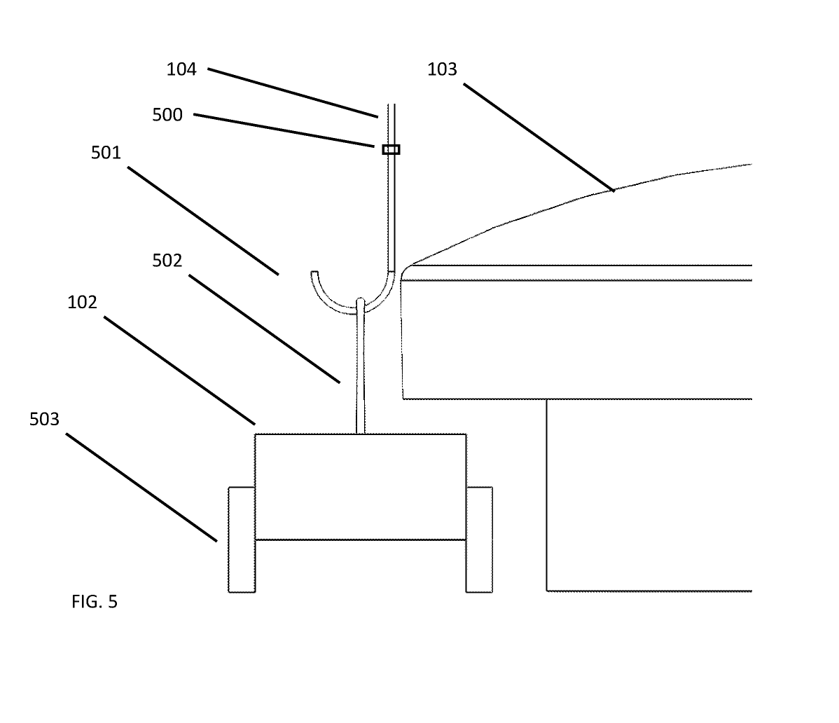

FIG. 5 illustrates a front view of a sensor vehicle 102 that can be slung below an unmanned aircraft by a tether 104 and lowered near the vent 103 of a municipal water tower 101 for remotely inspecting the interior of its vent 103 according to embodiments of the present inventions. In FIG. 5 a sensor pod 102 that can be slung below an unmanned aircraft 100 and lowered onto the surface of a water tower 101, or other infrastructure, for remote inspection purposes. A swivel device 500 is located along the tether 104 to allow the sensor pod 102 and the unmanned aircraft 100 or tether 104 to rotate freely relative to each other. If the tether 104 is embodied as a cable with power or communications link, slip ring devices can be integrated with the swivel device 500 and the electromechanical hoist 200. A positive capture mechanism 501, here embodied as a hook and loop 502 is used to couple the tether and the sensor pod. This positive capture mechanism 501 allows the sensor pod 102 to be decoupled from the unmanned aircraft 100 once on the surface of infrastructure. Likewise, the positive capture mechanism 501 is utilized to re-couple the sensor pod 102 to the tether 104 so that the sensor pod can be subsequently extracted from the surface of infrastructure using the unmanned aircraft 100. The positive capture mechanism 501 may utilize magnets, spring rings, lobster claws, bayonet clasps, barrel clasps, toggles, hooks, pearl clasps, hook and eye, hook-and-loop, any of which may either operate passively, actively (e.g. by use of a servomechanism or actuator), or via the use of springs.

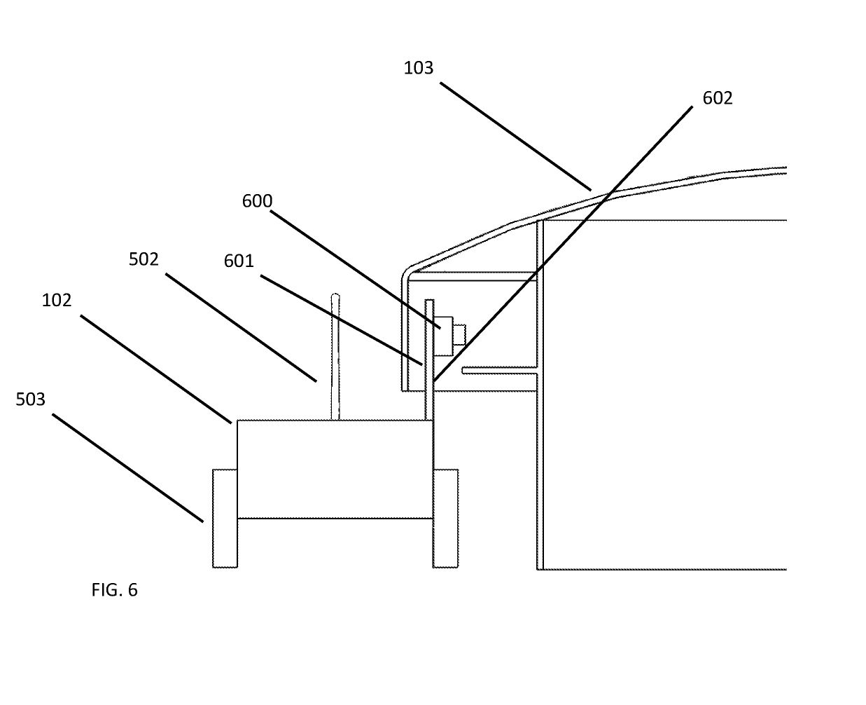

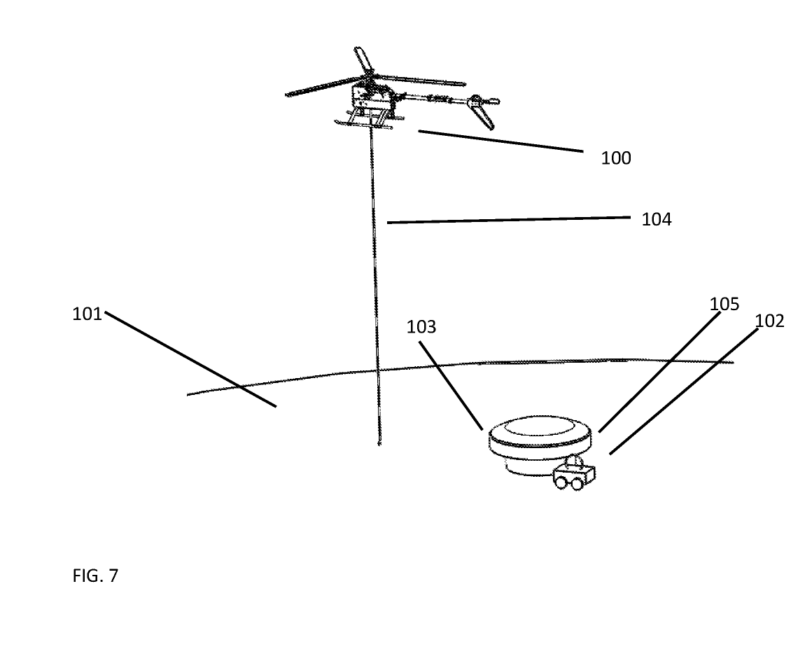

FIG. 6 illustrates a front view of a sensor pod 102 that was decoupled from an unmanned aircraft 100 on the surface of infrastructure according to embodiments of the present inventions. FIG. 6 shows a method by which a sensor vehicle 102 maneuvers along the surface of infrastructure to remotely inspect features thereof. The sensor pod 102, embodied as a ground robot, can be fitted with one or more electronic sensors 600 for remotely inspecting the vent 103 of a water tower 101 or other infrastructure or features thereof. The electronic sensors 600 can be embodied as cameras of any type with electro-optical or infrared sensors, LIDAR sensors, sonar sensors, barometric ambient air pressure sensors, ultra-sonic sensors for non-destructive testing, laser distance sensor, radar, ambient thermal sensors, radiation sensors, air sample sensors, and remote thermal sensors or any other electrically powered sensor. The electronic sensors 600 may be placed on an actuated platform 601 such that, when the sensor pod 102 is navigated under the water tower 101 vent 103, the platform 601 can be raised, lowered, rotated or translated in order to view the interior of the vent 103 better, or to avoid obstacles that are present inside the vent 103. The platform 601 can be embodied as a robotic arm with one or more actuated joints. The sensor pod 102 and actuated platform 601 can also be fitted with one or more lights 602 which can be embodied as light emitting diodes (LED) to continuously illuminate the vent 103 during its inspection. Likewise, the lights 602 can be embodied as short duration flash light (e.g. flash photography) to periodically illuminate the vent 103 during inspection. The sensor pod's 102 heading and position are controlled using one or more wheels 503 integrated with the sensor vehicle 102. Each wheel 503 can be powered by one or more electric motors. The electric motors can be driven clockwise or anti-clockwise such that the wheels 503 can generate left hand or right hand moments as well as forward or rearward motion. Besides wheels 503, other propulsion mechanisms can propel the sensor pod 102 on surface of the infrastructure.

A magnetic and GPS sensor 602 is used to measure and record the magnetic heading and position of the sensor pod 102 relative to the water tower 101 in order to correlate gathered inspection data with a physical location in or along the walls of the vent 103. In addition, this heading data can be used to inspect a specific point in the vent 103. The heading data can be displayed real time to an operator or can be incorporated into an automatic feedback control algorithm that, for example, slowly rotates the sensor pod while it moves around the perimeter of the vent. Any number of other sensors can be used to measure and record the heading and position of the sensor pod relative to the water tower and/or vent, such as an inertial navigation unit, a plurality of range sensors or a computer vision based navigation solution. One or more data receivers can be integrated with the sensor vehicle and receive commands from operators on the ground. The commands can be distributed to the sensor, sensor accessories, lights, the hoist, and the sensor vehicle 102 heading and position control mechanisms. One or more video and data transmitters can be integrated with the sensor vehicle 102 and transmit real time video and data to a receiver integrated with the unmanned aircraft 100 and rebroadcast to operators on the ground or directly transmitted from the sensor vehicle to operators on the ground.

A method for remotely inspecting infrastructure deploys a sensor pod onto the surface of the infrastructure using an unmanned aircraft. The method can drive the sensor pod, embodied as an unmanned ground vehicle, along the surface of the infrastructure being inspected. The method can deploy the sensor pod from the unmanned aircraft using a tether. The method can use an electromechanical hoist to raise and lower the sensor pod with relation to the unmanned aircraft and surface. The method can remotely drive the sensor pod. The method can autonomously drive the sensor pod. The method can gather data with one or more electronic sensors integrated with the sensor pod. The method can record imagery through a camera integrated with the sensor pod. The method can record position, heading and attitude of the sensor integrated with the sensor pod. The method can broadcast data collected from sensor pod. The method can light objects to be inspected with lights integrated on the sensor pod. The method can remotely drive the sensor pod in first person view from the vantage point of the sensor pod using cameras integrated with the sensor pod. The method can remotely drive the sensor pod in third person view from the vantage point of the aircraft using sensors integrated with the unmanned aircraft. The method can decouple the sensor pod from the unmanned aircraft once deployed on the surface of infrastructure. The method can subsequently re-couple the sensor pod with the unmanned aircraft for retrieval.

Any letter designations such as (a) or (b) etc. used to label steps of any of the method claims herein are step headers applied for reading convenience and are not to be used in interpreting an order or process sequence of claimed method steps. Any method claims that recite a particular order or process sequence will do so using the words of their text, not the letter designations.

Unless stated otherwise, terms such as “first” and “second” are used to arbitrarily distinguish between the elements such terms describe. Thus, these terms are not necessarily intended to indicate temporal or other prioritization of such elements.

Any trademarks listed herein are the property of their respective owners, and reference herein to such trademarks is generally intended to indicate the source of a particular product or service.

Although the inventions have been described and illustrated in the above description and drawings, it is understood that this description is by example only, and that numerous changes and modifications can be made by those skilled in the art without departing from the true spirit and scope of the inventions. Although the examples in the drawings depict only example constructions and embodiments, alternate embodiments are available given the teachings of the present patent disclosure.

What is claimed is:

1. A method for remotely inspecting infrastructure, comprising the steps of:
(a) deploying a sensor pod onto a surface of the infrastructure using an unmanned aircraft; and
(b) inspecting the infrastructure using the sensor pod after said step (a) of deploying.

2. A method according to claim 1,
wherein said step (a) of deploying the sensor pod comprises the substep of (a)(1) deploying the sensor pod embodied as an unmanned ground vehicle; and
wherein said step (b) of inspecting comprises the substep of (b)(1) driving the unmanned ground vehicle along the surface of the infrastructure being inspected.

3. A method according to claim 2, wherein said substep (b)(1) of driving further comprises the substep of (b)(a)(i) remotely driving the sensor pod in either a first person view from the vantage point of the sensor pod using cameras integrated with the sensor pod and a third person view from the vantage point of the unmanned aircraft using sensors integrated with the unmanned aircraft.

4. A method according to claim 1, wherein said step (a) of deploying the sensor pod comprises the substep of (a)(1) decoupling the sensor pod from the unmanned aircraft once deployed on the surface of infrastructure.

5. A method according to claim 4, wherein the method further comprises step (c) of re-coupling the sensor pod with the unmanned aircraft for retrieval after said step (b) of inspecting.

6. A method according to claim 1, wherein said step (a) of deploying the sensor pod comprises the substep of (a)(1) deploying the sensor pod from the unmanned aircraft using a tether.

7. A method according to claim 6, wherein the method further comprises step (c) of retrieving the sensor pod from the unmanned aircraft using the tether after said step (b) of inspecting.

8. A method according to claim 6, wherein said step (a)(1) of deploying the sensor pod using a tether further comprises the substep of (a)(1)(i) raising and lowering the sensor pod with relation to the unmanned aircraft and the surface using an electromechanical hoist.

9. A method according to claim 1, wherein said step (b) of inspecting comprises the substep of (b)(1) gathering data with one or more electronic sensors integrated with the sensor pod.

10. A method according to claim 1, wherein said step (b) of inspecting comprises the substep of (b)(1) lighting objects to be inspected with lights integrated on the sensor pod.

11. A method according to claim 1, wherein said step (b) of inspecting comprises the substep of (b)(1) inspecting a crevice of the surface of the infrastructure, the crevice of the surface of the infrastructure of a nature obstructed from view by the unmanned aircraft.

12. A system apparatus for remotely inspecting infrastructure, comprising:
a sensor pod comprising a remote connection node and sensors adapted to inspect a surface of the infrastructure; and
an unmanned aircraft adapted to interoperate with the remote connection node of the sensor pod.

13. A system apparatus according to claim 12, wherein the sensor pod is an unmanned ground vehicle comprising propulsion mechanisms adapted to drive the unmanned ground vehicle along the surface of the infrastructure being inspected.

14. A system apparatus according to claim 12,
wherein the unmanned aircraft comprises a tether adapted to deploy the sensor pod on the surface of the infrastructure; and
wherein remote connection node of the sensor pod is adapted to couple to the tether.

15. A system apparatus according to claim 14, wherein the tether is further adapted to retrieve the sensor pod after inspecting the surface of the infrastructure.

16. A system apparatus according to claim 14, wherein the tether comprises an electromechanical hoist adapted to raise and lower the sensor pod with relation to the unmanned aircraft and the surface.

17. A system apparatus according to claim 12, wherein the sensor pod comprises electronic sensors adapted to gather data when inspecting the surface of the infrastructure.

18. A system apparatus according to claim 17, wherein electronic sensors of the sensor pod are deployable in a crevice of the surface of the infrastructure, the crevice of the surface of the infrastructure of a nature obstructed from view by the unmanned aircraft.

19. A system apparatus according to claim 12, wherein the sensor pod comprises lights adapted to illuminate objects to be inspected.

20. A system apparatus according to claim 12,
wherein remote connection node of the sensor pod comprises a radio transceiver for receiving ground commands; and
wherein the unmanned aircraft comprises a radio repeater adapted to relay the ground commands to the sensor pod.
